(19) United States
(12) Patent Application Publication
(10) Pub. No.: US 2008/0052346 A1
(43) Pub. Date: Feb. 28, 2008

(54) System for mobile workforce, vehicle, asset and service management

(75) Inventors: Moshe Ben Bassat, Herzelia (IL); Israel Beniaminy, Ramat Gan (IL); Yaron Goldberg, Ra'anana (IL)

Correspondence Address: KATTEN MUCHIN ROSENMAN LLP, 575 MADISON AVENUE, NEW YORK, NY, 10022-2585, US

(73) Assignee: CLICKSOFTWARE TECHNOLOGIES, LTD.

(21) Appl. No.: 11/796,456

(22) Filed: Apr. 27, 2007

(30) Foreign Application Priority Data
Aug. 22, 2006 (IL) 177617

(51) Int. Cl. G06F 15/16

(52) U.S. Cl. 709/203

(57) ABSTRACT

An integrated, pervasive service management system of a service organization for a mobile workforce and vehicle that includes an application server to coordinate communications between the system and field service entities that include service technician communication devices. The system also includes an integration hub server to communicate between the service optimization suite and back office systems of the service organization and a universal service model to automatically coordinate the details of a service contract concerning service to be provided to customers of the organization. A optional service optimization suite to provide integrated, optimized service can also be provided.

### FIELD OF THE INVENTION

The present invention relates generally to systems for mobile service management, and more particularly to a system for mobile workforce, vehicle, asset and service management

### BACKGROUND OF THE INVENTION

Traditional mobile software focuses on sending data to the technician and receiving data from the technician. The basic elements involved in communication in the service organization environment are illustrated in prior art FIG. 1. First, of course, there are the customers 110. People within the service organization include the in-house workforce 120, the executives 130, the dispatchers 140 and the field workforce 150, comprising service technicians. Inanimate objects include equipment 160, parts 170 and vehicles 180.

Prior art FIG. 2 is a block diagram of the communication process involving the service technician. The service technician's communications devices 210 typically include a laptop, a technician's hand-held communication device and a standard telephone. An application server 220 is also provided.

An integration hub server 240 is a form of Enterprise Middleware, which is a framework and set of programming tools for the uniform creation and control of intermediary programs such as Proxy servers, transcoding processors and any program that sits somewhere between two end points in a network.

There are still issues to be resolved. Coverage areas remain limited, for example, and data synchronization among devices can be problematic. The various business processes which extend to the mobile resources (people, vehicles, equipment, spare parts, tools etc.) are not managed in a coordinated and collaborative manner. There are also other field entities which can benefit from an integrated, pervasive communication platform.

### SUMMARY OF THE PRESENT INVENTION

Accordingly, it is a principal object of the present invention to provide pervasive coverage.

It is another principal object of the present invention to provide reliable data synchronization among devices.

It is further principal object of the present invention to provide other field “entities” with an integrated, pervasive communication platform.

Accordingly, the present invention provides an integrated, pervasive service management system of a service organization for a mobile workforce and vehicle that includes an application server to coordinate communications between the system and field service entities that include service technician communication devices. The system also includes an integration hub server to communicate between the service optimization suite and back office systems of the service organization and a universal service model to automatically coordinate the details of a service contract concerning service to be provided to customers of the organization. A service optimization suite to provide integrated, optimized service can also be included,

Accordingly, the present invention provides a communication platform and mobility server to manage the communication needs of all other field entities:
Tech's specialized application devices;
Vehicles;
Equipment being monitored; and
Parts with an RFID or barcode.

### The Universal Service Model (USM) and database of the service optimization suite offers a flexible, system integration friendly tool to describe a wide range of the real life service environment.

The mobile server of the present invention is also extended to manage and coordinate the communication needs of the following:

Tech's mobile communication device:
Laptop;
Handheld; and
Phone;

GPS—global positioning system:
Tech's communication device; and
Vehicle-mounted;

Part's Id and inventory:
Radio frequency identification (RFID); and

Device Resource Management (DRM) monitoring.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

Prior art FIG. 1 is a schematic illustration of the basic elements involved in communication in the service organization environment;

Prior art FIG. 2 is a block diagram of the communication process involving the service technician;

FIG. 3 is a block diagram, illustrating the extension of the communication process involving the service technician to all relevant entities, constructed according to the principles of the present invention;

FIG. 4 is a block diagram, illustrating the extension of the communication process through a universal service Model and database, constructed according to the principles of the present invention; and

FIG. 5 is a schematic block diagram, illustrating the where, for whom, what, when, by who, with what and how business objects, constructed according to the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

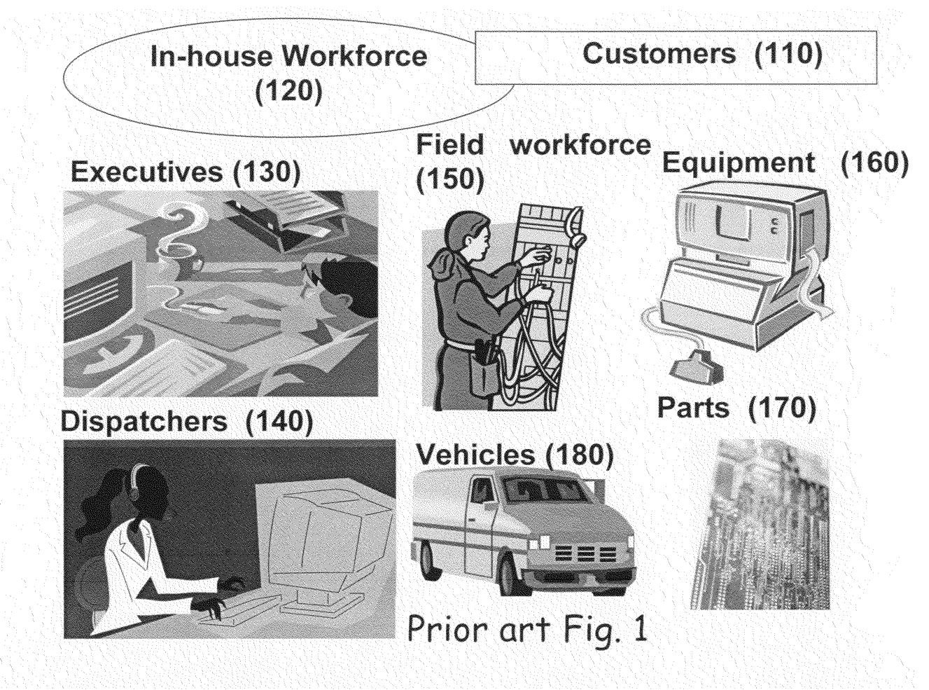

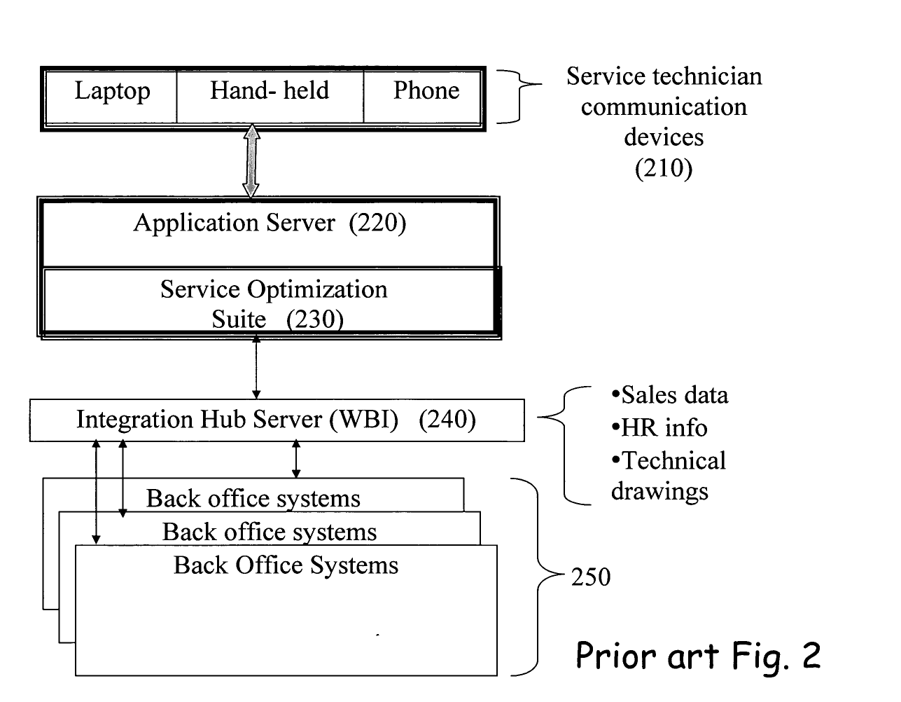

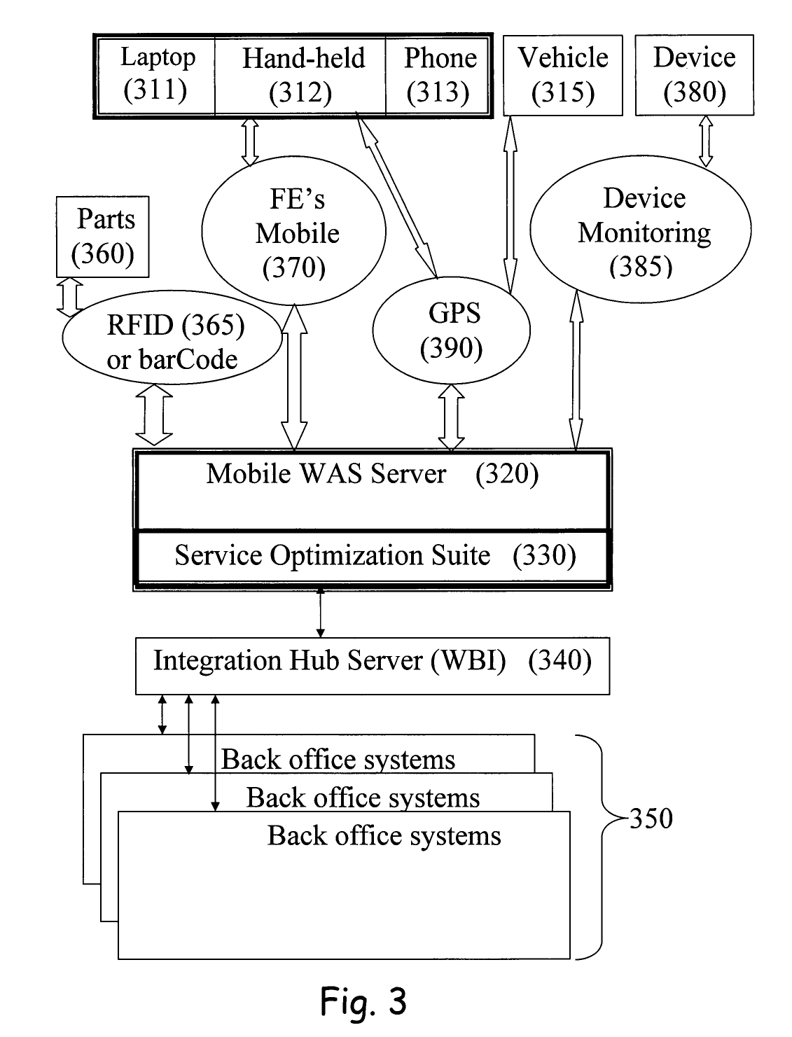

FIG. 3 is a block diagram, illustrating the extension of the communication process involving the service technician to all relevant entities, constructed according to the principles of the present invention. Again, the service technician's communications devices typically include a laptop 311, a technician's hand-held communication device 312 and a standard telephone 313; an application server 320 is provided; a service optimization suite 330 is used to coordinate the communication activities; an integration hub server 340; and back office systems 350 are coordinated.

Accordingly, the present invention provides a communication platform and mobility server to manage the communication needs of all field entities:
Tech's device 311-313;
Vehicle 315;
Equipment 380 being monitored 385; and
Part 360 with an RFID or barcode 365.

Tech's mobile communication device:
Laptop 311;
Handheld 312; and
Phone 313;

GPS—global positioning system 390:
Tech's communication device 311-313; and
Vehicle-mounted 315;

Parts ID and inventory:
Radio frequency identification (RFID) or barcode 365; and

Device Resource Management (DRM) monitoring 385.

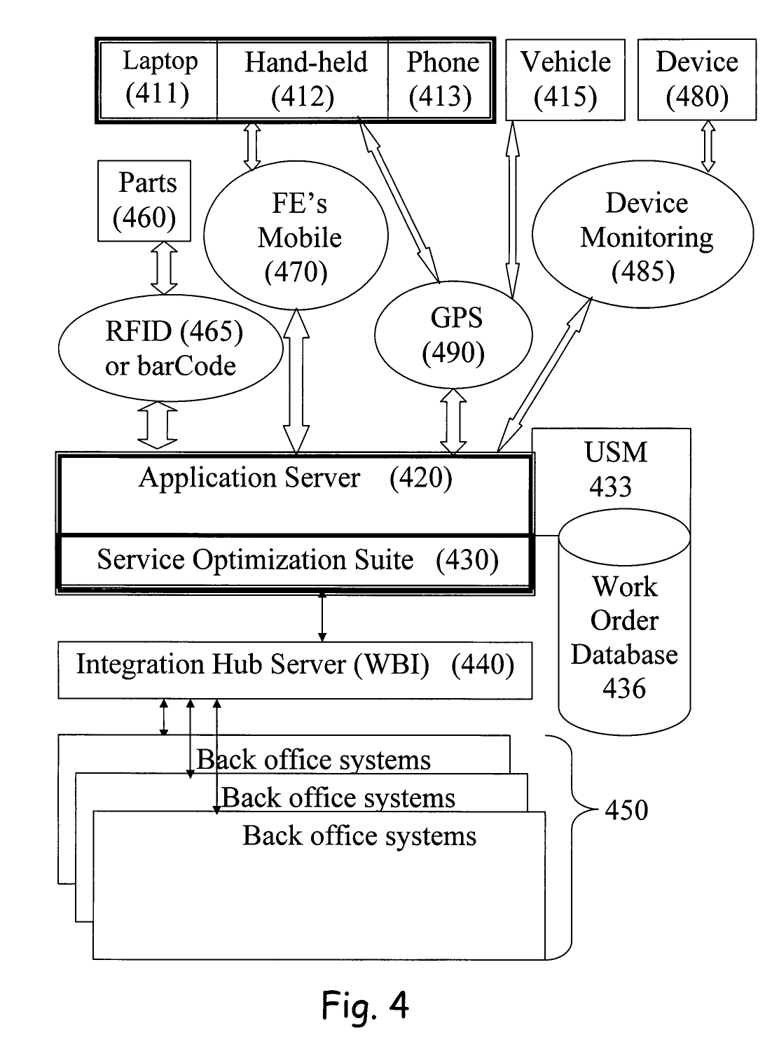

FIG. 4 is a block diagram, illustrating the extension of the communication process through a universal service model 433 and database 436, constructed according to the principles of the present invention. Again, the service technician's communications devices typically include a laptop 411, a technician's hand-held communication device 412 and a standard telephone 413; an application server 420 is provided; a service optimization suite 430 is used to coordinate the communication activities; an integration hub server 440; and back office systems 450 are coordinated.

Accordingly, the present invention provides a communication platform and mobility server to manage the communication needs of all field entities:
Tech's device 411-413;
Vehicle 415;
Equipment 480 being monitored 485; and
Part 460 with an RFID or barcode 465.

Tech's mobile communication device:
Laptop 411;
Handheld 412; and
Phone 413;

GPS—global positioning system 490:
Tech's communication device 411-413; and
Vehicle-mounted 415;

Part's Id and inventory:
Radio frequency identification (RFID) or barcode 465; and

Device Resource Management (DRM) monitoring 485.

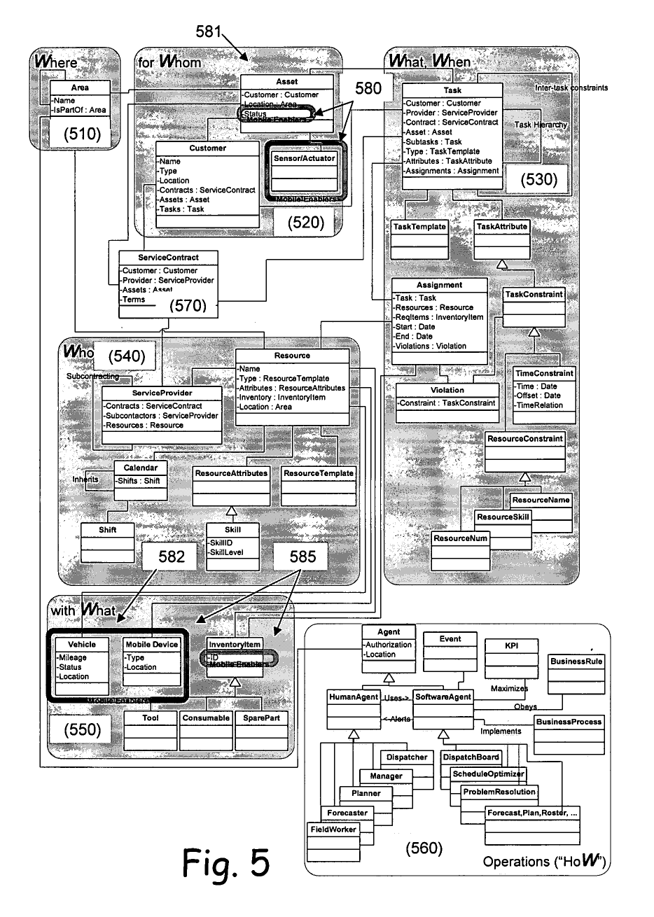

Universal Service Model (USM) 433 and database 436 of service optimization suite 430 offers a flexible, system integration friendly tool to describe a wide range of the real life service environment. This includes where, for whom, what, when, by who, with what and how business objects, as illustrated in FIG. 5 below, status diagrams, events, triggers, alerts, etc., from simple break-fix to complex maintenance requiring a multi-person team to deliver a multi-stage job over multiple days.

To explain the impact of USM, it is useful to compare USM to the prior art. In the prior art, communication between the entities has limited or no semantics, and where semantics are defined, they are defined at the low level of single messages or isolated parts of the business process flow. Therefore, all interactions between the entities have to be laboriously designed, reviewed and coded into software on many different systems, such as Back-office servers for Customer Relationship Management, Logistics, Workforce Management etc. as well as the field entities mentioned above. These interactions would function correctly only if all these entities have been programmed correctly according to the business requirements, where these requirements exist only in the knowledge and understanding of the people who created the overall system. This also places severe limitations on the ability to flexibly change the behavior of the overall system to respond to changing business requirements, new types of field activities, regulations, trade-union agreements, etc.

By contrast, the inclusion of USM in the present invention raises the level of semantics so that each interaction is explicitly related, in all entities taking part in that interaction, to the actual business issues. For example, a spare part is related by USM not just to its identity but also to the “Who” (technician to whom the part was assigned); the “What” (for what work order will the part be used); the “When” (when should the part be available to be picked up by the technician) and so on. Applying the requirements, definitions and semantics at the level of the USM and across all the entities involved automatically enables cohesive view and control of all activities and all entities participating in them, while reducing the need for specific and detailed coding required to implement the business requirements.

In the previous example, the fact that the spare part is associated with a work order automatically creates an association with the time when the part needs to be available. This provides the information required by the logistics back-office systems. Moreover, if the time assigned for dispatching the work order changes, or if the work order is cancelled, the relationships within USM automatically notify the logistics systems. To achieve the same effect without USM, one needs to consider several different events, design the work processes for each, determine the entities and systems that need to participate in these processes, design the messages that need to be activated by each event and their flow between the systems and entities and implement and test this design.

With USM, a large part of this work is automated. Moreover, when some change is required, e.g. replacing the logistics systems, or adding information to the RFID tags incorporated in each spare part, the change is performed at the high level of the USM. Performing the change at this high level has several benefits: it takes far less work, it has lower risks of error and it is much closer to the language and thinking used by non-technical people who state the requirements.

Another benefit of USM is that it incorporates knowledge about the field service world. It is not a general-purpose domain-independent model such as the models defined in UML (Unified Modeling Language), but a highly detailed model of how field service is performed. Thus, it includes “Best Practices” identified by leading service organizations, and offers these benefits to other service organizations which are newer, smaller, or undergoing significant changes.

The present invention combining service optimization suite 430 and USM 433 with database 436 provides:

a. Benefits of automation and optimization;

b. The service application infra-structure to push and send information from back office systems to the field;

c. Clients can ask for and receive additional data that perhaps does not play a direct role in optimization, but is highly beneficial;

d. Integration points for extending capabilities;

e. State-of-the-art generic service management computing infra-structure; and

f. State-of-the-art service processes.

FIG. 5 is a schematic block diagram, illustrating the details of the where 510, for whom 520, what and when 530, by who 540, with what 550 and how 560 business objects, constructed according to the principles of the present invention. These business objects are coordinated according to a service contract 580. The mobile enabler components 580 and 585 are highlighted.

The benefit of the USM is in its ability to capture all entities, interactions and relationships which take part in delivering service using any combination of mobile and static resources. This capture allows the creation, update and monitoring of flexible service processes specified in the language of the service organization. It also automatically handles many of the details involved in getting these interactions to work as they are intended to work, configuring and managing the various components taking part in the interaction, even when these components are in separate locations, being part of different software and hardware systems, etc.

FIG. 5 shows part of the USM diagram. Mobile enabler components 580 and 585 have the same role in USM as any other parts, but are detailed here as an example of how the present invention functions. They enable USM to function in a pervasive manner across different locations and systems, even when entities taking part in the interactions are connected by inconsistently available connections. For example, consider the USM component representing the vehicle 582 used by the mobile service professional. This component manifests in the real world within the vehicle as well as in centralized service management and optimization systems. In its manifestation inside the vehicle, this mobile-enabler component can report its location, mileage, diagnostic indicators etc. Since several other parts of USM are manifested within the vehicle, it can keep track of what tasks the vehicle has been assigned to even when out of communication with the central office, and potentially perform some processes autonomously.

In its manifestation inside a centralized service optimization system, this mobile-enabler component allows effective dispatch decisions based on accurate and up-to-date location and status data. In its manifestation inside a centralized asset management system 581, this mobile-enabler component allows identification of abnormal situations (e.g. speeding, presence of vehicle where it should not be) and effective planning of maintenance activities for the vehicle.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. An integrated, pervasive service management system of a service organization for a mobile workforce and vehicle comprising:
an application server to coordinate communications between said system and field service entities comprising at least service technician communication devices;
an integration hub server to communicate between said service optimization suite and back office systems of said service organization; and
a universal service model to automatically coordinate the details of a service contract concerning service to be provided to customers of said organization.

2. The system of claim 1, further comprising a work order database linked with and to provide data for said universal service model.

3. The system of claim 1, further comprising a service optimization suite to provide integrated, optimized service.

4. The system of claim 1, further comprising at least one back office system linked with said integration hub server.

5. The system of claim 1, wherein said service technician communication devices comprises at least one of:
a laptop;
a technician's hand-held communication device; and
a phone.

6. The system of claim 5, further comprising at least one of:
a vehicle;
a field engineer's mobile phone;
parts being monitored; and
equipment being monitored.

7. The system of claim 5, further comprising a global positioning system (GPS) provided to enable said application server to ascertain the location of said technician's hand-held communication device.

8. The system of claim 6, wherein said parts being monitored are provided with radio frequency identification (RFID) tags.

9. The system of claim 6, wherein said parts being monitored are provided with barcodes.

10. The system of claim 1, wherein said universal service model automatically coordinates the details of a service contract concerning service to be provided to customers of said organization by coordination the by who, what, when, where, for whom and how specified by said service contract.
